(19) United States
(12) Patent Application Publication
(10) Pub. No.: US 2003/0145730 A1
(43) Pub. Date: Aug. 7, 2003

(54) Method for separating fuel out of an off-gas and associated device

(76) Inventor: Walter Preidel, Erlangen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/368,158

(22) Filed: Feb. 18, 2003

Related U.S. Application Data
(63) Continuation of application No. PCT/DE01/02980, filed on Aug. 3, 2001.

(30) Foreign Application Priority Data
Aug. 16, 2000 (DE) 100 40 087.6

(51) Int. Cl. B01D 53/14

(52) U.S. Cl. 95/211; 96/290; 95/237

(57) ABSTRACT

Particularly in the case of a fuel cell, the waste gas contains, in essence, carbon dioxide and methanol. According to the invention, the carbon dioxide/methanol gas mixture is directed through a porous material and is scrubbed out in the counter-current flow using water. The device utilizes a gas scrubber to separate out the fuel.

### CROSS-REFERENCE TO RELATED APPLICATION

This application is a continuation of copending International Application No. PCT/DE01/02980, filed Aug. 3, 2001, which designated the United States and which was not published in English.

### BACKGROUND OF THE INVENTION

1. Field of the Invention

The invention relates to a method for separating fuel from an off-gas, in particular the anode off-gas from a fuel cell, the off-gas substantially containing carbon dioxide and also the fuel. In addition, the invention relates to the associated device that is enabled to carry out the method. In the invention, the fuel is preferably, although not exclusively, methanol. In particular methanol can be liquefied as a mixture of methanol and water according to the concentration of methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline, ethanol or methanol. A DMFC (Direct Methanol Fuel Cell), by contrast, operates directly with methanol (CH₃OH) as fuel. The function and status of DMFCs are described in detail by the inventor in “VIK-Berichte”, No. 214 (November 1999), pages 55 to 62.

The off-gas, or exhaust gas, at the anode of a direct methanol fuel cell (DMFC) is the carbon dioxide formed as a result of the anode reaction. At the standard operating temperatures of the DMFC of over 80° C., this gas contains a methanol fraction corresponding to the methanol concentration and water. If this methanol leaves the fuel cell system through the anode off-gas, this would reduce the utilization of fuel. Therefore, on the one hand before the anode off-gas is separated from the anode circuit of the DMFC, this liquid-gas mixture is cooled, liquid and gas are separated or the supersaturated dissolved carbon dioxide is removed from the liquid by a gas separator. In this case too, however, at a reduced temperature the result is a methanol partial pressure in the off-gas which corresponds to the pressure, temperature and methanol concentration in the anode liquid.

Even at temperatures of 40° C. and ambient pressure, the volumetric proportion of methanol is so high that this methanol proportion significantly exceeds the permitted limits for hydrocarbon emissions from vehicles with internal combustion engines. Therefore, this requires a process which allows as much of the methanol as possible to be recovered from the off-gas.

The methanol emissions can be at least supposedly reduced if the anode off-gas is admixed with the cathode outgoing air. The significantly increased flow of gas means that the proportion of methanol is reduced relative to the overall volume. However, the absolute quantity of methanol remains constant.

### SUMMARY OF THE INVENTION

It is accordingly an object of the invention to provide a method of separating out fuel from an off-gas (exhaust gas) and an associated device, which overcome the above-mentioned disadvantages of the heretofore-known devices and methods of this general type and which allows the absolute quantity of methanol in the off-gas to be reduced.

With the foregoing and other objects in view there is provided, in accordance with the invention, a method of separating a fuel from an off-gas, preferably from an anode off-gas from a fuel cell, which comprises:

passing an off-gas primarily containing carbon dioxide and the fuel in a carbon dioxide/fuel mixture through a porous material; and

pumping water in countercurrent to the off-gas, and substantially completely taking up the fuel from the carbon dioxide/fuel mixture.

In accordance with an added feature of the invention, the fuel is methanol.

In accordance with an additional feature of the invention, the method comprises conducting an anode off-gas of a direct methanol fuel cell as the off-gas and cooling a cathode off-gas at a cathode of the fuel cell with a cathode off-gas cooler, using some water formed at the cathode off-gas cooler as the water in the pumping step, and adding the water to an anode circuit.

In a first embodiment, the counter-current is conducted in vertical flow. Alternatively, the counter-current is a horizontal flow.

With the above and other objects in view there is also provided, in accordance with the invention, a device for separating a fuel from an off-gas configured to carry out the above-outlined method. The device according to the invention is provided with a gas scrubber for exchanging fluids in a gas phase, on the one hand, and in a liquid phase, on the other hand.

In accordance with again an added feature of the invention, the gas scrubber (20) is a vertical configuration comprising a steel pipe (21) filled with packing elements.

In accordance with again an additional feature of the invention, the gas scrubber (30) has vertically arranged lamellae (32) which are arranged in interrupted or open form and offset with respect to one another.

In accordance with again another feature of the invention, horizontally arranged lamellae in the gas scrubber (30) are in each case arranged offset in interrupted or open form.

In accordance with a concomitant feature of the invention, the gas scrubber (30) in each case comprises perforated metal sheets and meshes and/or meshes which are in each case arranged offset with respect to one another.

In the invention, the carbon dioxide/fuel mixture is passed through a porous material and water, which almost completely takes up the fuel from the carbon dioxide/fuel mixture, is fed in countercurrent by means of a pump. The result is that the anode liquid is cooled, with an associated drop in the amount of fuel expelled.

Although U.S. Pat. No. 5,156,926 (German patent DE 38 12 812 C1) already disclos a fuel cell in which a heat exchanger and a gas-scrubbing installation are present in order to recover the residual fuel components which are present in residual gases and to return them to the process, that prior art document deals with the treatment of a two-substance mixture in the off-gas, with water of reaction being used as carrier liquid. By contrast, the invention is used to treat a three-substance mixture which treats CO₂ and methanol vapor with water in countercurrent, with the result that, in addition to the CO₂ as now pure off-gas, liquid methanol and water are now formed as a liquid mixture. However, this mixture represents the fuel/electrolyte mixture for the DMFC.

Other features which are considered as characteristic for the invention are set forth in the appended claims.

Although the invention is illustrated and described herein as embodied in a method for separating fuel out of an off-gas and associated device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic functional illustration of the system components for operation of a fuel cell;

FIG. 2 is a diagrammatic view of a first embodiment of a gas scrubber according to the invention used in the system of FIG. 1; and

FIG. 3 is a diagrammatic view of a second embodiment of the gas scrubber according to the invention used in the system of FIG. 1.

### DESCRIPTION OF THE PREFERRED EMBODIMENTS

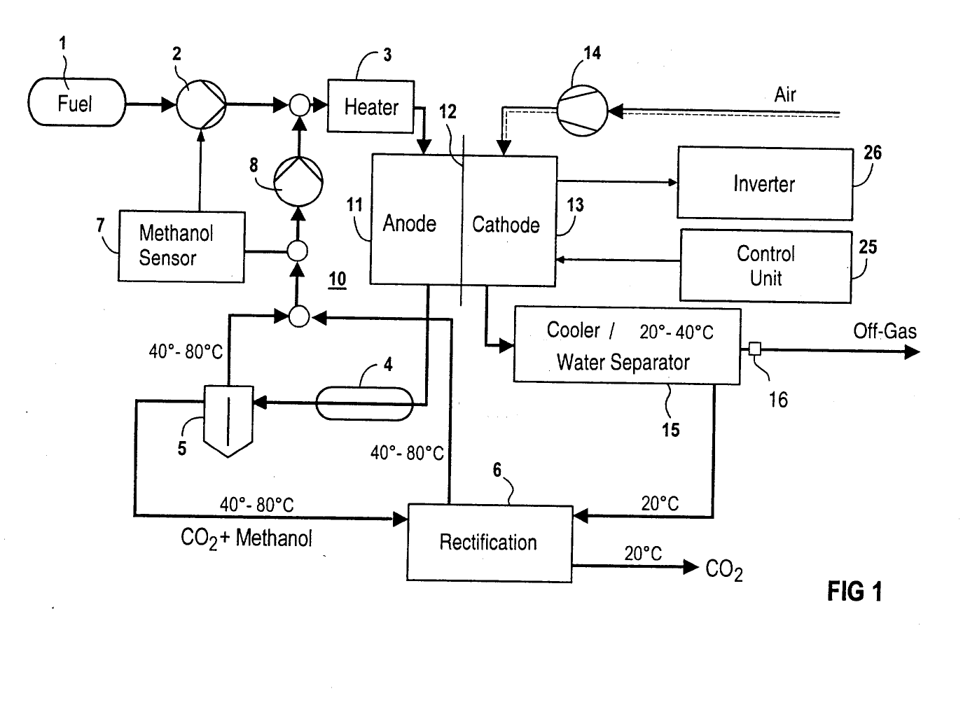

Referring now to the figures of the drawing in detail and first, particularly, to FIG. 1 thereof, there is shown a detailed illustration of a system with a DMFC in which the fuel used is methanol. The methanol is stored in a fuel tank 1 with a downstream metering pump 2 and a heating device 3. The liquid methanol passes as operating medium through the pump 2 and the heater 3 to a fuel cell unit 10. The fuel cell unit 10 in the exemplary embodiment is a direct methanol fuel cell (DMFC) and it is substantially characterized by an anode 11, a membrane 12 and a cathode 13. The anode part is assigned a cooler 4, a CO₂ separator 5, a unit 6 for rectification, and a methanol sensor 8.

On the cathode side, there is a compressor 14 for air, a cooler or water separator 15 for the cathode liquid and a CO₂ sensor 16. Furthermore, for operation of the installation, there is a unit 25 for controlling the fuel cell unit 10 and, ideally, an electrical inverter 26.

The fuel cell unit 10 is part of a fuel cell system in which in particular individual units form a fuel cell stack. Nothing changes in terms of the peripherals shown in FIG. 1.

FIG. 1 gives the operating temperatures from the individual units. The results are temperatures in the range from 40 to 80° C. in the anode circuit, while in the cathode circuit the temperatures are less than 40° C. and downstream of the cooler/water separator 15 the temperatures are approximately 20° C.

When a DMFC fuel cell is operating, the following must be observed on the anode side: the cooling of the anode liquid after it leaves the stack is used to reduce the expulsion of methanol. However, the lower temperature of the gas separator 5 leads to an increase in the carbon dioxide concentration, since carbon dioxide is more readily soluble in water at lower temperatures. Furthermore, it is therefore necessary to heat the anode liquid by means of a heat exchanger upstream of the stack, so that the temperature gradient in the stack does not become excessive.

It is significantly more favorable for the carbon dioxide to be separated out immediately downstream of the admission-pressure regulator following the anode outlet of the stack. At higher temperatures, the solubility of carbon dioxide in water is lower, so that the carbon dioxide concentration in the anode liquid is reduced. Therefore, the formation of gas bubbles starts somewhat later in the stack.

A drawback is the high level of methanol in the carbon dioxide of the off-gas discharged from the gas separator 5.

However, if this carbon dioxide/methanol gas mixture is then passed in countercurrent through a pipe through which fluid is flowing and part of the water formed at the cathode off-gas cooler is supplied by means of a pump, this water takes up almost all the methanol. This water can be added to the anode circuit. As a result, although the carbon dioxide concentration in the anode circuit is increased slightly, the methanol is advantageously substantially quantitatively recovered. An upright pipe structure is advantageous for operation of a gas-scrubbing installation of this type.

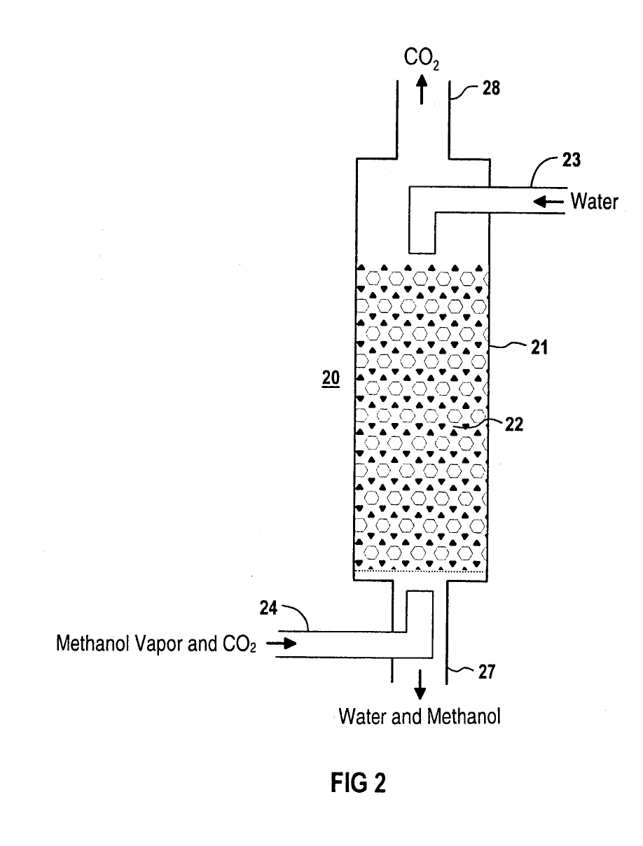

FIG. 2 illustrates a device of this type. A gas scrubber 20 substantially comprises a vertically oriented steel pipe 21, which is filled with packing elements 22. Water is flushed through the gas scrubber 20 from the top via a line 23, while the methanol vapor together with the carbon dioxide is supplied from the bottom via a further line 24. As a result of the gas scrub, water with methanol is discharged at the lower outlet 27 of the steel pipe 21, while the CO₂ can escape at the upper outlet 28 of the steel pipe 21.

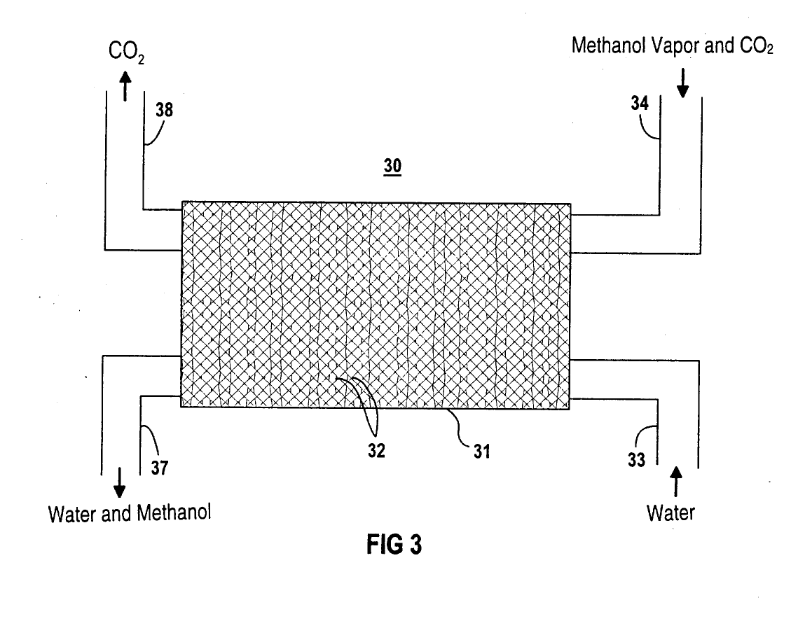

The configuration shown in FIG. 2 corresponds to the standard embodiment of a conventional gas scrubber. However, this design is generally contradictory to the desired compact structure of a fuel cell, in particular the DMFC. A more suitable horizontal structure of a gas scrubber is illustrated in FIG. 3.

In FIG. 3, a horizontally oriented gas scrubber 31 has feed lines 33 for water and 34 for methanol vapor with carbon dioxide on one side. As a result, water with methanol is discharged via an outlet line 37 and returned to the process, while CO₂ can escape via an outlet line 38 on the other side of the vessel 31.

The gas scrubber 30 shown in FIG. 3 comprises the horizontally oriented vessel 31 with lamellae 32 arranged vertically therein. The vertically arranged lamellae 32 are in each case in interrupted or open offset form, so that there can be an intensive exchange between gas phase and liquid. In this way, rectification is achieved even with a horizontal orientation. To achieve an inexpensive design, it is also possible to use offset perforated metal sheets or meshes or a combination of the two.

FIGS. 2 and 3 therefore show the advantageous application of the rectification to the separation of liquids/vapors and a gas in countercurrent with water. They therefore make it possible to exploit the system conditions in a fuel cell which is operated with liquid fuel. In this way, operation in particular of a direct methanol fuel cell can be improved.

The solution to the problem of separating carbon dioxide out of the water/fuel mixture which has been described above on the basis of a DMFC which is operated with methanol as fuel can also be transferred to fuel cells which are operated with other fuels. However, when it is used for the DMFC with a methanol/water mixture as fuel, it is of essential importance that three substances, namely carbon dioxide (CO₂), methanol (CH₃OH) and water (H₂O), are being treated as separate components. In the process, the methanol in vapor form from the off-gas is advantageously converted into liquid methanol mixed with water. The latter mixture can be added directly to the anode circuit as a fuel/electrolyte mixture.

I claim:

1. A method of separating a fuel from an off-gas, which comprises:
passing an off-gas primarily containing carbon dioxide and the fuel in a carbon dioxide/fuel mixture through a porous material; and
pumping water in countercurrent to the off-gas, and substantially completely taking up the fuel from the carbon dioxide/fuel mixture.

2. The method according to claim 1, wherein the off-gas is an anode off-gas from a fuel cell.

3. The method according to claim 1, wherein the fuel is methanol.

4. The method according to claim 1, which comprises conducting an anode off-gas of a direct methanol fuel cell as the off-gas and cooling a cathode off-gas at a cathode of the fuel cell with a cathode off-gas cooler, using some water formed at the cathode off-gas cooler as the water in the pumping step, and adding the water to an anode circuit.

5. The method according to claim 4, which comprises conducting the counter-current in vertical flow.

6. The method according to claim 4, which comprises conducting the counter-current in horizontal flow.

7. A device for separating a fuel from an off-gas configured to carry out the method according to claim 1, comprising a gas scrubber for exchanging fluids in a gas phase and in a liquid phase.

8. The device according to claim 7, wherein said gas scrubber is a vertical configuration scrubber comprising a steel pipe filled with packing elements.

9. The device according to claim 7, wherein said gas scrubber has vertically arranged lamellae arranged in interrupted form and offset with respect to one another.

10. The device according to claim 7, wherein said gas scrubber has vertically arranged lamellae arranged in open form and offset with respect to one another.

11. The device according to claim 7, wherein said gas scrubber has horizontally arranged lamellae in each case arranged offset in interrupted form.

12. The device according to claim 7, wherein said gas scrubber has horizontally arranged lamellae in each case arranged offset in open form.

13. The device according to claim 7, wherein said gas scrubber comprises perforated metal sheets and meshes.

14. The device according to claim 7, wherein said gas scrubber comprises a plurality of mutually offset meshes.
